(19) United States
(12) Patent Application Publication
(10) Pub. No.: US 2005/0056817 A1
(43) Pub. Date: Mar. 17, 2005

(54) Staple remover

(75) Inventor: Yong-Woo Lee, Seoul (KR)

Correspondence Address: DARBY & DARBY P.C., P. O. BOX 5257, NEW YORK, NY, 10150-5257, US

(73) Assignee: Pankyo Co., Ltd., Gimpo (KR)

(21) Appl. No.: 10/928,012

(22) Filed: Aug. 27, 2004

(30) Foreign Application Priority Data
Sep. 16, 2003 (KR) 2003-29327

(51) Int. Cl. B25C 11/00

(52) U.S. Cl. 254/28

(57) ABSTRACT

The object of the present invention is to provide a new staple remover in which not only staples having different standards can be removed simply through a curved member formed at the front side of the staple remover in accordance with the present invention and but also the incompletely removed staples can be held and completely removed with a simple method through contacting members formed at the staple remover. The staple remover comprises: upper and lower members in which they are rotatably combined with each other through a hinge portion which is equipped to rear ends of the upper and lower members and repelled, facing with each other, by an elastic force of an elastic member combined at the position adjacent to the hinge portion; a plurality of staple removing members formed vertically to a lower portion of the upper member and the upper portion of the lower member, respectively, for removing a staple fixed to several kinds of document or paper; and a curved member with a plate shape formed vertically and upwardly between the outside staple removing member pair of the front end of the lower member, whereby the curved member is inserted between the several kinds of document or paper and the staple, thereby removing the staple.

### BACKGROUND OF THE INVENTION

1. Field of the Invention

The present invention relates to a staple remover in which a structure of a staple remover to remove an office staple for pressing and fixing a large volume of document or paper is changed so that it may be applied to staples of every standards, thereby capable of removing the staples more simply.

2. Description of the Background Art

Generally, at the state that a large volume of document or paper are fixed by using staples, when the fixed document or paper is classified again by adding or removing a sheet of paper or document, a staple remover has been used for easily removing the staples.

FIGS. 1a and 1b are perspective views showing a staple remover for removing a staple in accordance with a conventional art. As shown in FIGS. 1a and 1b, an upper member 30 having a handle 32 formed at its upper surface and a lower member 10 having a handle 12 formed at its lower surface are rotated and combined with each other through a hinge portion 14 which is equipped to almost rear ends of the upper and lower members 30 and 10, so that the upper and lower members 30 and 10 can be contacted with each other selectively. Outside staple removing members 20 are formed vertically along the upper both edges of the lower member 10 and inside staple removing members 22 are formed vertically with a constant interval between a pair of outside staple removing members 20 in parallel to the outside staple removing members 20. A pair of insertion staple removing members 40 are formed at the lower portion of the upper member 30 so that they may be inserted between a pair of outside and inside staple removing members.

At this time, in the outside and inside staple removing members 20 and 40, and the insertion staple removing members 40, they have curved portions which are curved upwardly or downwardly and their front ends are pointed and protruded in order to be inserted to the staple easily.

Also, an elastic member (not shown) is combined at the position adjacent to the hinge portion 14 fixing the upper and lower members 30 and 10 rotatably so that the front ends of the upper and lower members 30 and 10 may be maintained as an elastically repellent state, facing with each other.

On the other hand, holding members 16 are extended from the rear ends of upper and lower members 30 and 10 and crossed with each other. The staple which does not removed completely by the outside and inside staple removing members 20 and 22 and the insertion staple removing members 40 is pressed and fixed by the holding members 16 and thereafter can be removed easily.

However, as described above, according to the conventional staple remover, there are disadvantages that a plurality of staple removing members must be constructed for removing staples having different standards and when removing a staple having an arbitrary standard, the removing process does not performed completely.

According this, when removing an incompletely removed staple by using the holding member constructed to the end of the staple removing member, the removing process is very awkward, so that not only the user's inconvenience is increased and but also when using the staple remover, a specific portion of the user's body is pressed and damaged.

According the staple remover of the conventional art, since the manufacturing processes are increased and complicated, the cost of production is raised and the economic efficiency goes on declining.

### SUMMARY OF THE INVENTION

Accordingly, it is an object to improve the problems of the staple removing member in accordance with the conventional art, as described above, and provide a new staple remover in which not only staples having different standards can be removed simply through a curved member formed at the front side of the staple remover in accordance with the present invention and but also the incompletely removed staples can be held and completely removed with a simple method through contacting members formed at the staple remover.

In order to achieve the above-described object of the invention, there is provided a staple remover comprising: upper and lower members in which they are rotatably combined with each other through a hinge portion which is equipped to rear ends of the upper and lower members and repelled, facing with each other, by an elastic force of an elastic member combined at the position adjacent to the hinge portion; a plurality of staple removing members formed vertically to a lower portion of the upper member and the upper portion of the lower member, respectively, for removing a staple fixed to several kinds of document or paper; and a curved member with a plate shape formed vertically and upwardly between the outside staple removing member pair of the front end of the lower member, whereby the curved member is inserted between the several kinds of document or paper and the staple, thereby removing the staple.

Preferably, contacting members are formed at the outside staple removing member pair formed at the lower member and the shapes of the contacting members are formed in a manner that the partial portions of the curved portions are pushed inwardly and moved, and whereby after removing the staple by pressing upper and lower members, the staple is guided through the curved portions of the outside and insertion staple removing members, secured firmly between the contacting members and the insertion staple removing members of the upper member and removed completely by an external force.

More preferably, the upper front end portion of the curved member is pointed at the end so that it may be inserted easily between the staple and several document or paper when removing the staple.

According to the present invention, as described above, when removing the staple fixed to several kinds of document or paper, a removing work can perform regardless of standards completely and simply.

### BRIEF DESCRIPTION OF THE DRAWINGS

The present invention will become better understood with reference to the accompanying drawings which are given only by way of illustration and thus are not limitative of the present invention, wherein:

FIG. 1a is a front perspective view illustrating a staple remover in accordance with a conventional art;

FIG. 1b is a rear perspective view illustrating a staple remover in accordance with a conventional art;

FIG. 2 is a front perspective view illustrating a staple remover in accordance with the present invention;

FIG. 3 is a rear perspective view illustrating a staple remover in accordance with the present invention;

FIG. 4 is a front view illustrating a staple remover in accordance with the present invention;

FIGS. 5a and 5b are side views illustrating use states of a staple remover in accordance with the present invention; and

FIGS. 6 and 7 are front cross-sectional views illustrating use states of a staple remover in accordance with the present invention.

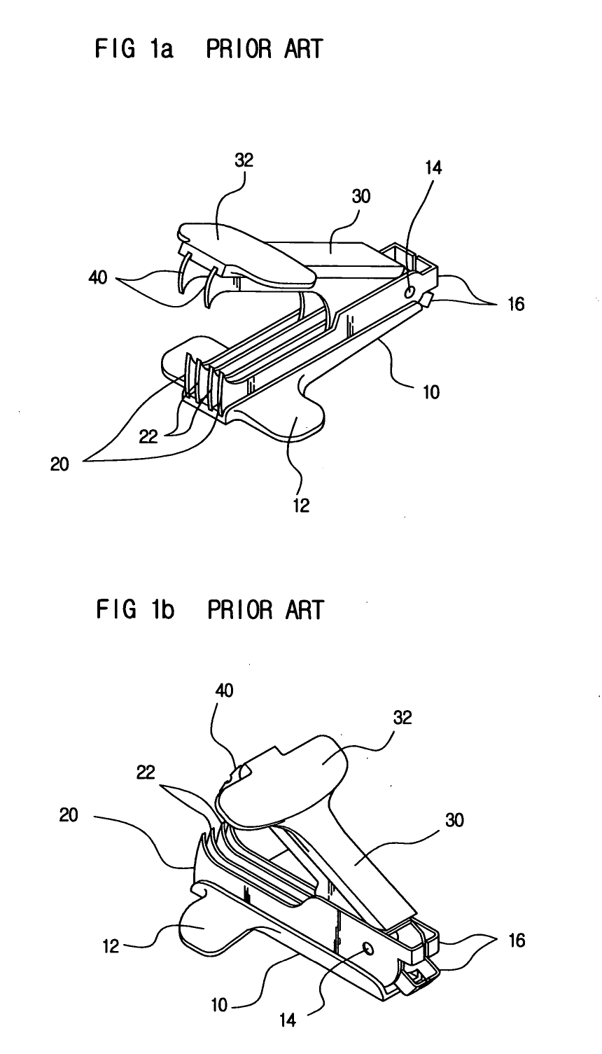

### DETAILED DESCRIPTION OF THE PREFERRED EMBODIMENTS

A staple remover in accordance with preferred embodiments of the present invention will now be described in detail with reference to the accompanying drawings.

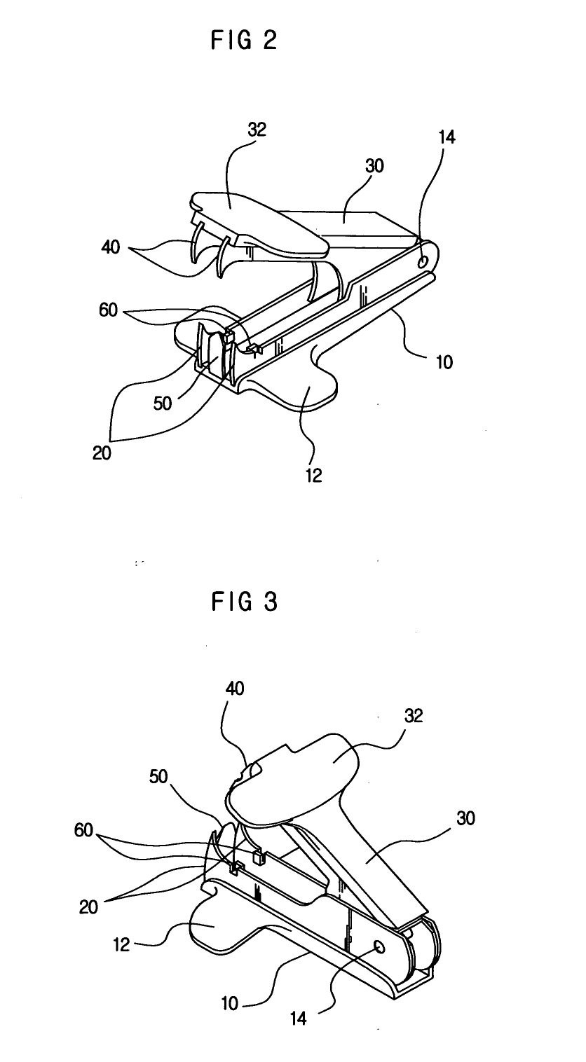

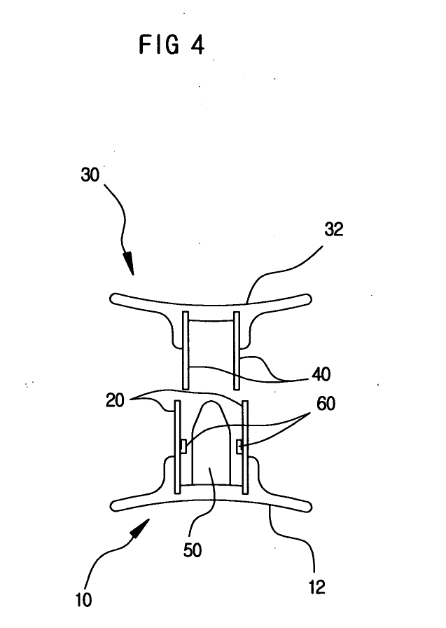

FIG. 2 is a front perspective view illustrating a staple remover in accordance with the present invention, FIG. 3 is a rear perspective view illustrating a staple remover in accordance with the present invention, and FIG. 4 is a front view illustrating a staple remover in accordance with the present invention. As shown in FIGS. 2 to 4, a handle 12 is formed at an upper surface of an upper member 30 and a handle 32 is formed at a lower surface of a lower member 10. At this state, the upper and lower members 30 and 10 are combined rotatably with each other through a hinge portion 14 which is penetrated to a rear end side of the upper and lower members 30 and 10. An elastic member (not shown) is installed at the position adjacent to the hinge member 14 so that the front ends of the upper and lower members 30 and 10 may be maintained as an elastically repellent state, facing with each other.

Outside staple removing members 20 are formed vertically along the upper both edges of the lower member 10 and a curved member 50 is formed at the front end of the lower member 10 corresponding between a pair of outside staple removing members 20. The curved member 50 has nearly a rectangular plate shape and formed by curving the bottom plate vertically.

At this time, the curved member 50 has a thin thickness so that it may be inserted easily between a staple and several kinds of document or paper when removing the staple fixed to the document or paper and its front surface is pointed at the end.

Also, a pair of insertion staple removing members 40 are formed vertically at the lower portion of the upper member 30 so that they may be positioned at the point adjacent to the inside of the outside staple removing members 20.

At this time, in a pair of outside staple removing members 20 formed at the lower member 10 and a pair of insertion staple removing members 40 formed at the upper member 30, their front ends are pointed and protruded sharply upwardly or downwardly and the ends are curved toward their rear ends with a constant distance.

Also, at the points that the curved portions of the outside staple removing member pair 20 formed along the edges of lower member 10 are finished, the contacting members 60 are formed. The shapes of the contacting members are formed in a manner that the partial portions of the curved portions are pushed inwardly and moved. The upper ends of the contacting members 60 are positioned at the points corresponding to the insertion staple removing members 40 of the upper member 30. When removing a staple by using the staple remover according to the present invention, the staple is removed through the outside and insertion staple removing members 20 and 40 and the curved member 50, moved along the curved portions of the outside and insertion staple removing members 20 and 40, thereafter secured firmly between the contacting members 60 and the insertion staple removing members 40 and removed completely by an external force.

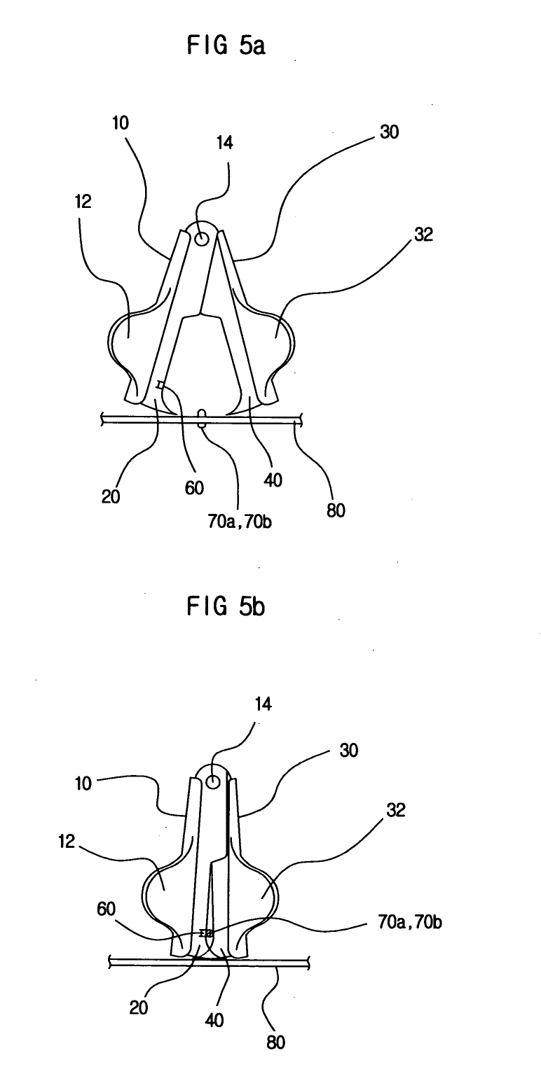

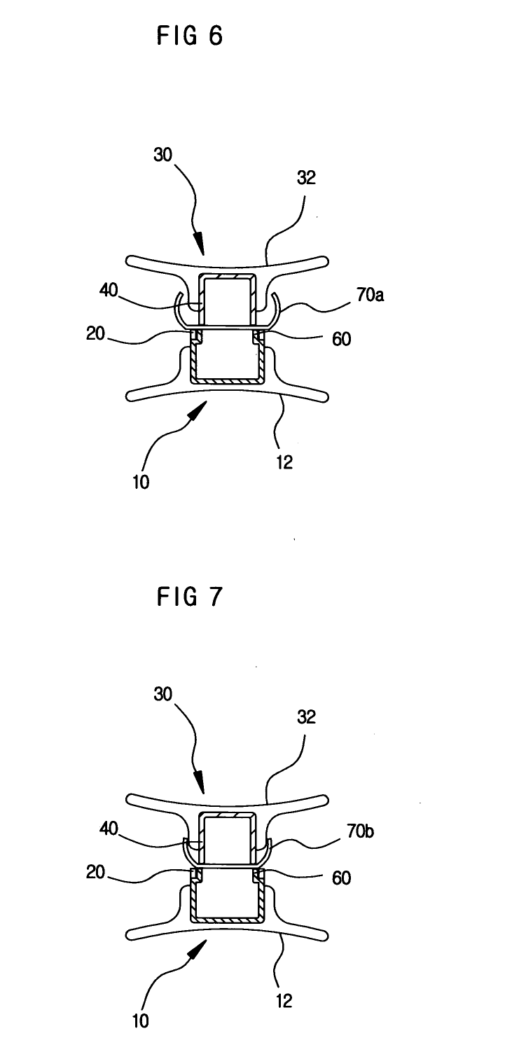

As constructed above, an operation of the staple remover according to the present embodiment will be described with reference to the accompanying drawings, FIGS. 2 to 7.

Firstly, when removing a staple 70a with a wide width or a thick thickness (for example, number 33 staple) fixing several kinds of document or paper by using the staple remover according to the present invention, at the state that the end portions of the outside staple removing members 20 of the lower member 10 and of the insertion staple removing members 40 of the upper member 30 are positioned between the several kinds of document or paper 80 and the staple 70a, the front ends of the upper and lower members 10 and 30 are contacted with each other by pressing the handles 12 and 32 of the lower and upper members 10 and 30 and then the outside staple removing members 20 and the insertion staple removing members 40 are penetrated between several kinds of document or paper 80 and the staple 70a and crossed with each other.

According this, the staple 70a fixed to the several kinds of document or paper 80 are removed through a sharp front ends of the outside and insertion staple removing members 20 and 40, moved along the curved portions formed at the rear portions of the outside and insertion staple removing members 20 and 40 and then positioned in the neighborhood of the contacting member 60 of the outside staple removing members 20.

At this time, when the staple 70a is not completely removed from the several kinds of document or paper 80, the handles 12 and 32 of the lower and upper members 10 and 30 are completely pressed, so that the staple 70a is secured at the point that the contacting member 60 and the insertion staple removing members 40 are contacted with each other and thereafter the staple 70a can be completely removed from the several kinds of document or paper 80 by a user's external force.

On the other hand, when removing a staple 70b with a narrow width (for example, number 10 staple) by using the staple remover according to the present invention, at the state that the curved member 50 of the lower member 10 is inserted between the several kinds of document or paper 80 and the staple 70b, the insertion staple removing members 40 of the upper members 30 are crossed with the curved member 50 and penetrated between the several kinds of document or paper 80 and the staple 70b by pressing the handles 12 and 32 of the lower and upper members 10 and 30.

Also, at this time, the staple 70b removed through the curved member 50 and the insertion staple removing members 40 is moved along the curved portions formed at the rear portions of the outside and insertion staple removing members 20 and 40 and then positioned in the neighborhood of the contacting members 60 of the outside staple removing members 20. According this, when the staple 70b is not completely removed from the several kinds of document or paper 80, at the state that the staple 70b is firmly secured by the contacting member 60 and the insertion staple removing members 40, the staple 70b can be completely removed by an applied external force.

As described above, according to the present invention, there is an advantage that when removing the staple fixed to several kinds of document or paper, a removing work can perform regardless of standards through the outside and insertion staple removing members and the curved member.

Also, when performing the work for removing the staple, since an incompletely removed staple can be removed completely in simple, so that the troublesome matters in the conventional art can be solved and the user's convenience can be enhanced.

According to the staple remover of the present invention, there are also several advantages that the staple removing work can perform very simply and completely, the structure of the device is very simple and production processes and the cost of the product can be reduced, so that the economical efficiency can be enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

1. A staple remover comprising:
upper and lower members in which they are rotatably combined with each other through a hinge portion which is equipped to rear ends of the upper and lower members and repelled, facing with each other, by an elastic force of an elastic member combined at the position adjacent to the hinge portion;
a plurality of staple removing members formed vertically to a lower portion of the upper member and the upper portion of the lower member, respectively, for removing a staple fixed to several kinds of document or paper; and
a curved member with a plate shape formed vertically and upwardly between the outside staple removing member pair of the front end of the lower member, whereby the curved member is inserted between the several kinds of document or paper and the staple, thereby removing the staple.

2. The staple remover of claim 1, wherein contacting members are formed at the outside staple removing member pair formed at the lower member and the shapes of the contacting members are formed in a manner that the partial portions of the curved portions are pushed inwardly and moved, and whereby after removing the staple by pressing upper and lower members, the staple is guided through the curved portions of the outside and insertion staple removing members, secured firmly between the contacting members and the insertion staple removing members of the upper member and removed completely by an external force.

3. The staple remover of claim 1, wherein the upper front end portion of the curved member is pointed at the end so that it may be inserted easily between the staple and several document or paper when removing the staple.
